(19) United States
(12) Patent Application Publication
(10) Pub. No.: US 2005/0266215 A1
(43) Pub. Date: Dec. 1, 2005

(54) Curl and thickness control for white reflector film

(75) Inventor: Thomas M. Laney, Spencerport, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/857,517

(22) Filed: May 28, 2004

(51) Int. Cl. B32B 7/02

(52) U.S. Cl. 428/212

(57) ABSTRACT

A display apparatus includes a reflective layer that significantly enhances light delivered to a display surface, especially in displays requiring small dimension components. The reflective layers are substantially immune to shrinkage and curl that may result from duration heat testing. The reflective layer includes at least two layers, where one of the layers includes a crystalline polyester material.

### CROSS REFERENCE TO RELATED APPLICATIONS

The present application is related to U.S. patent application Ser. No. 10/718,902, filed Nov. 21, 2003, Thomas M. Laney et al.; Ser. No. 10/719,762 filed Nov. 21, 2003, Thomas M. Laney et al.; Ser. No. 10/706,524, filed Nov. 12, 2003, Thomas M. Laney et al.; and Ser. No. 10/719,728, filed Nov. 21, 2003, Thomas M. Laney et al. The disclosures of these applications are specifically incorporated herein by reference.

### FIELD OF THE INVENTION

A reflector film is described for use in enhancing light utilization in electrophoric displays.

### BACKGROUND OF THE INVENTION

Light-valves are implemented in a wide variety of display technologies. For example, microdisplay panels are gaining in popularity in many applications such as televisions, computer monitors, point of sale displays, personal digital assistants and electronic cinema to mention a few applications.

Many light valves are based on liquid crystal (LC) technologies. Some of the LC technologies are prefaced on transmittance of the light through the LC device (panel), while others are prefaced on the light traversing the panel twice, after being reflected at a far surface of the panel.

The LC material is used to selectively rotate the axes of the liquid crystal molecules. As is well known, by application of a voltage across the LC panel, the direction of the LC molecules can be controlled and the state of polarization of the reflected light is selectively changed. As such, by selective switching of the transistors in the array, the LC medium can be used to modulate the light with image information. Often, this modulation provides dark-state light at certain picture elements (pixels) and bright-state light at others, where the polarization state governs the state of the light. Thereby, an image is created on a screen by the selective polarization transformation by the LC panel and optics to form the image or ‘picture.’

In many LCD systems, the light from a source is selectively polarized in a particular orientation prior to being incident on the LC layer. The LC layer may have a voltage selectively applied to orient the molecules of the material in a certain manner. The polarization of the light that is incident on the LC layer is then selectively altered upon traversing through the LC layer. Light in one linear polarization state is transmitted by a polarizer (often referred to as an analyzer) as the bright state light; while light of an orthogonal polarization state is reflected or absorbed by the analyzer as the dark-state light.

While LCD devices are becoming ubiquitous in display and microdisplay applications, there are certain drawbacks associated with known devices. For example, in known devices, the efficient transmission of light from the light source to the image surface can be less than acceptable. This is particularly a problem in LCD microdisplays, where the dimensions of the LCD device are ever-reduced.

What is needed, therefore, is an apparatus that overcomes at least the drawbacks of known devices described above.

### SUMMARY OF THE INVENTION

In accordance with an illustrative embodiment, a reflective layer includes a first layer comprised at least partially of a crystalline material. The reflective layer also includes a second layer, which comprises polyester and which is voided sufficiently to provide a reflectivity of at least 94%, wherein the first layer and the second layer have a combined thickness of at most 150 μm.

In accordance with another example embodiment, a method of fabricating a reflecting layer includes forming a first layer, which is at least partially crystalline. The method also includes forming a second layer, which is at least partially amorphous; and crystallizing a portion of the second layer, wherein the reflective layer has a reflectivity of at least 94%, and the first layer and the second layer have a combined thickness of at most 150 μm.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a cross-sectional representation of an image display device in accordance with an example embodiment.

FIG. 2 is a partial cross-sectional representation of a reflective layer in accordance with an example embodiment.

FIG. 3 is a tabular representation showing the heat set temperature, percentage of crystalline material and the resultant reflectance in accordance with an example embodiment.

FIG. 4 is a graphical representation of the % reflectance versus heat set temperature in accordance with an example embodiment.

### DETAILED DESCRIPTION OF THE INVENTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known apparati and methods may be omitted so as to not obscure the description of the present invention. Such methods and apparati and methods are clearly within the contemplation of the inventors in carrying out the example embodiments. Wherever possible, like numerals refer to like features throughout.

Briefly, and as described in accordance with example embodiments, a reflective film provides a heightened level of illumination in electrophoric displays such as LCD devices. The reflective film includes a first layer that is a substantially crystalline material, a second layer that comprises both amorphous and crystalline material, and a third layer that is substantially the same as the second layer. Beneficially, after being subjected to temperature durability testing, the reflective film substantially retains it flatness and dimension, and is not susceptible to a significant amount of shrinkage or curl. Moreover, as will become clearer as the present description continues, light is recycled after being reflected from various elements useful in effecting an image in a display device or system. These and other example embodiments are described presently.

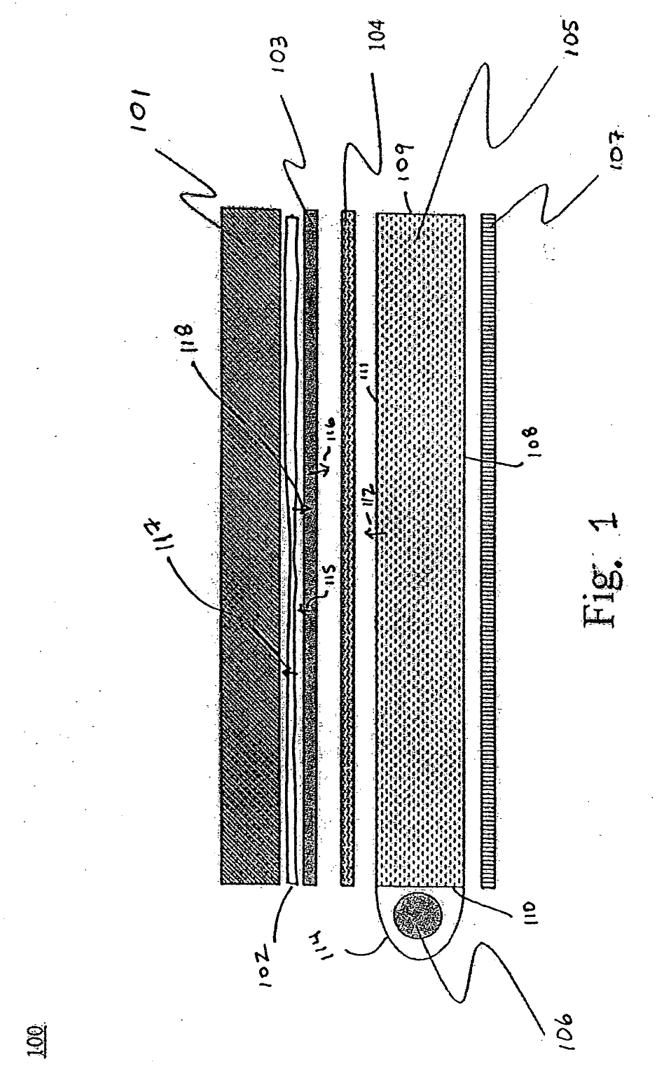

FIG. 1 is a cross-sectional view of a light-valve imaging device 100 of an example embodiment. The imaging device 100 includes a transmissive light-valve 101, which is illustratively an LC panel. A backlight assembly includes a polarization selective reflector 102, a brightness enhancement layer 103 and a diffuser layer 104. As is readily appreciated by one of ordinary skill in the art, the backlight assembly provides a uniform light distribution to the light valve 101, with an angular distribution of light that is designed to meet the angular field of view required by an end-user.

Beneath the diffuser layer 104 is a light guide 105, which is coupled to at least one light source 106. The light guide 105 has a diffusive reflector layer 107 disposed over at least a one surface. Illustratively, layer 107 is disposed over a bottom surface 108 of the light guide 105 with an air gap between the bottom surface 108 and the layer 107. In addition, they layer 107 may be disposed over at least one other surface 109 (but not surfaces 110 or 111, of course) of the light guide 105. In keeping with an example embodiment, the layer 107 is of the type described in detail in conjunction with illustrative embodiments herein.

The light source 106 includes a reflector 114, which serves to improve the intensity of the light coupled from the light source to the light guide 105. In accordance with an example embodiment, the reflector 114 is a specular reflector of the light. Optionally, the reflector 114 may be of the material of the reflector layer of the illustrative embodiments described herein. In accordance with an example embodiment, the light source is one of a cold cathode fluorescent lamp (CCFL), an ultra-high pressure (UHP) gas lamp or other source of randomly polarized white light.

The light source 106 is coupled to the light guide 105 and light 112 is optimally transmitted via surface 111. Light 112 is randomly polarized and may be transmitted through surface 111 toward the light valve 101. Alternatively, light 112 may be transmitted back to the light guide 105 through surface 111 after reflection from elements of the backlight assembly or the light valve 101, and may be recycled and re-transmitted. This recycling is useful in improving the light efficiency; and the light efficiency of the device 100 is further improved through the use of the reflective layer 107 of the illustrative embodiments.

After traversing the diffusive layer 104, the light 112 traverses the brightness enhancement layer 103. The brightness enhancement layer 103 beneficially provides light substantially in a prescribed angular distribution 115 to the selectively reflective polarizer 102. To this end, the brightness enhancement layer 103 may redirect light for recycling that would be otherwise lost, and unobserved at the image screen because it is too far off axis to contribute to the image. As will be clearer as the present description continues, at least a portion of light 116 is recycled and transmitted to the light valve 101, providing improved on-axis brightness.

In accordance with example embodiments, the brightness enhancement (BER) layer 103 a known BER layer such as a Vikuiti™ Display Enhancement film, which is offered by Minnesota Mining and Manufacturing, Incorporated. Of course, the known BER films may be used as layer 103.

Light 115 is transmitted to the reflective polarizer 102, which transmits light 117 of a first polarization state and reflects light 118 of a second polarization state, which is orthogonally polarized relative to the first polarization. Illustratively, the reflective polarizer 102 is a polarization beam splitter. The transmitted light 117 is then incident on the light valve 101, which modulates the light incident thereon and transmits light 119 that forms the image (not shown).

As is well known in the display arts, a certain portion of the light from the light source 106 is reflected back from the various elements of the device 100. Moreover, and as alluded to above, a portion of the light from the light source may not be efficiently transmitted to the LC panel 101 and the elements of the backlight assembly. Due to its increased reflectivity compared to known reflectors, especially thin reflectors, the material of layer 107 of the illustrative embodiments is beneficial in improving both the amount of light transmitted from the light source initially, and the recycling of light reflected within the device 101. Certain illustrative embodiments of the layer 107 and characteristics thereof are described presently.

As can be appreciated from a review of the example embodiments of FIG. 1, white reflector films useful in LCD and other electrophoric displays need to be thin but also need to exhibit good lay-flat, curl and dimension stability. These characteristics help to provide improved manufacturing and assemblage performance as well as end-use performance for uniform illumination for backlight displays.

However, if a white reflector film is prone to shrinkage and curl problems, it is difficult to provide a film that will reflect light in a uniform manner. Such problems potentially create non-uniform brightness that will make it difficult to read the display information and therefore be less desirable to the end-user. Problems with curl and dimensional stability also present problem with the manufacture and assemblage of these displays. To this end, when sheets are cut to fit into a display, if they are not flat at time of cutting, the final reflector may not be cut square along its axis and therefore may not fully cover the backlight. Dimensional stability may also cause similar problems during assemblage.

In the end-use of a fully assembled display, any dimensional changes in the white reflector may cause it to pull away or shift its position in relation to other films or to the backlight. Such a problem may cause non-uniform illumination that will result in information or images that are less discernable resulting in consumer dissatisfaction.

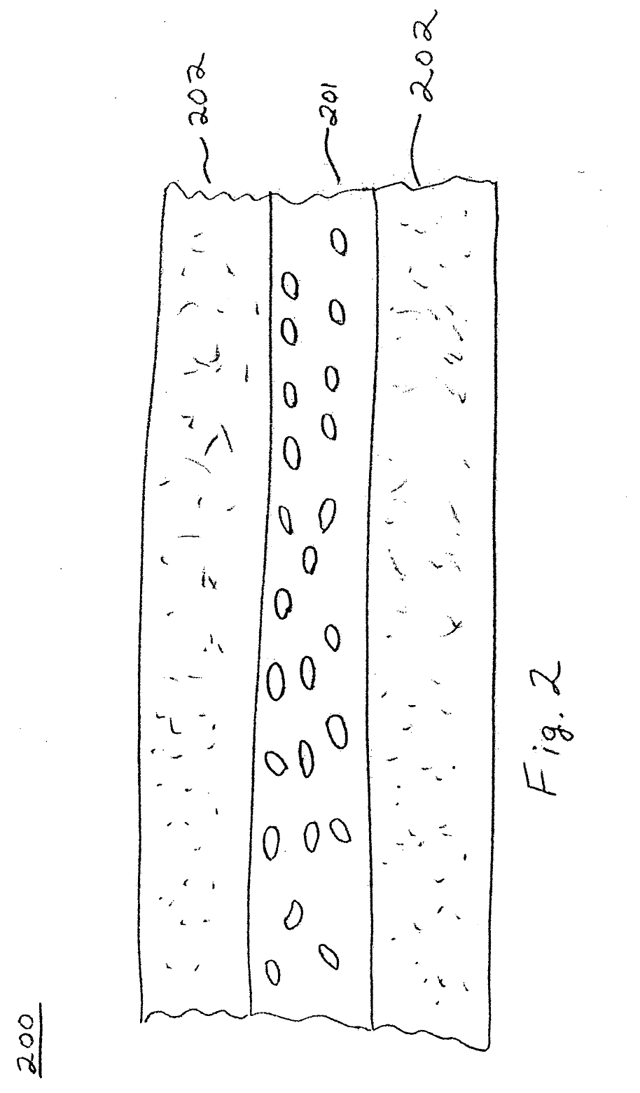

FIG. 2 is a cross-sectional view of a reflector layer 200 in accordance with an illustrative embodiment. The reflector layer 200 may be used, for example, as layer 107 of the illustrative embodiments of FIG. 1. The layer 200 includes a first layer 201, which has substantially identical layers 202 disposed on either side thereof. It is noted that the incorporation of two layers 202 is beneficial, but not essential; in fact only one layer 202 would be needed to effect a reflector layer 200 according to an example embodiment.

In general, the reflector layer 200 is a reflector that substantially reflects light across the visible with a reflectivity of at least 94% at thicknesses of approximately 250 μm or less. In fact, as will be described in greater detail herein, while the layer 200 provides significant improvement in the reflectance compared to known reflectors having a thickness of approximately 150 μm or approximately 75 μm, the structure and materials of the reflector layer 200 of the illustrative embodiments also provide improvement in reflectance at thicknesses of 250 μm. Moreover, the reflector layer 200 provides significant improvement in curl and shrinkage when compared to known reflectors. In an example embodiment, the first layer 201 comprises approximately 50% to approximately 70% of the total thickness, with the remaining approximately 50% to approximately 30% of the total thickness equally split among the second layers 202. In other example embodiment, reflective layer 200 comprises a first layer 201 and a single second layer 202, where the first layer comprises approximately 50% to approximately 70% of the total thickness and the second layer 202 comprises the remaining approximately 50% to approximately 30% of the total thickness of layer 200.

The first layer 201 is illustratively a voided polymer layer that is at least partially crystalline. To this end, according to an example embodiment, the first layer 201 is comprised of crystalline material that constitutes approximately 90 wt % to approximately 40 wt % of the weight of the layer 201. The remaining portion is amorphous material. The first layer 201 provides structural rigidity to the second layers 202 that are heavily loaded with a void-creating agent. The structural rigidity fosters manufacturability and is beneficial to meeting duration testing requirements as they relate to curl and dimensional shrinkage. Moreover, the layer 201 includes voids that are beneficial in reflecting light across the visible spectrum.

In an illustrative embodiment, the first layer 201 contains fine voids that are initiated by the barium sulfate particles (not shown) of sufficiently small size and concentration. The shape of the void is not particularly restricted, generally being an elongated sphere, or an ellipsoid or a flattened sphere. The size of the barium sulfate particles which initiate the voids upon stretching should have an average particle size of approximately 0.1 μm to approximately 10.0, usually approximately 0.3 μm to approximately 2.0 μm, and usefully 0.5 to 1.5 μm.

The second layers 202 are partially of an amorphous polyester, and is loaded to a substantial degree with a void inducing material such as barium sulfate (BaSO₄) or similar material that is useful in providing voids in polymers. In an example embodiment, the second layer is comprised of crystalline polyester that constitutes approximately 5 wt % to approximately 45 wt % of the weight of the layer. In example embodiments amorphous polyester refers to any polyester that does not significantly form crystal domains under any conditions. Similarly, in example embodiments crystalline polyester refers to any polyester that can be in an amorphous state but can also form crystalline domains when subjected to either high temperatures or high strains or both.

In accordance with an illustrative embodiment, the second layer 202 is a blend of amorphous and crystalline polyesters in which fine voids containing barium sulfate particles are formed at a level sufficient to provide visible reflectance above 94% at thicknesses below 150 μm or that can have UV absorptive particles in an amount sufficient to minimize UV reflectance from 200 to 400 nm to below 40%. In the reflective optical element according to an illustrative embodiment, fine voids are formed in the polyester film by loading barium sulfate in a voided layer at levels between approximately 30 wt % and approximately 70 wt %. If desired, UV reflectance is reduced to below 40% by loading UV absorbing particles in the voided layer, typically at approximately 0.5 wt % to approximately 10 wt %.

In order to provide improved reflection, particularly in thin reflective layers, in illustrative embodiments, at least one second layer 202 is provided and contains barium sulfate particles present at a concentration in the range of approximately 30.0 wt % to approximately 70.0 wt %, or approximately 40 wt % to approximately 65 wt %, or approximately 50 wt % to approximately 60 wt %. These concentrations are particularly beneficial when the desired thickness of the layer 200 is less than 150 μm. If the concentration of barium sulfate is above approximately 70 wt %, the amount of the fine voids is too great, and film breakage occurs in the film formation process. In keeping with illustrative embodiments, higher levels of reflectivity are attained, illustratively approximately 96% or approximately 97% for thin films of less than 150 μm thickness.

In accordance with illustrative embodiments, it is useful to provide crystalline polyester materials in the second layer 202. Applicants have found that this to reduces the susceptibility to curl and shrinkage during durability testing at elevated temperatures. As will become clearer as the present description continues, in addition to improving the reflector layer 200 for long-term use, the reflectance is improved. As such, according to an illustrative embodiment it is beneficial to provide the second layer with voids and to provide both crystalline and amorphous polyester materials in beneficial ratios that both maximize reflectance and minimize curl and shrinkage during durability testing.

It is noted that as used in connection with illustrative embodiments, the term “polyester” means a polymer obtained by the condensation polymerization, at least in part, of a diol and a dicarboxylic acid. As the dicarboxylic acid, one of terephthalic acid, isophthalic acid, phthalic acid, naphthalenedicarboxylic acid, adipic acid, or sebacic acid can be used. As the diol, one or more of ethylene glycol, trimethylene glycol, tetramethylene glycol, or cyclohexanedimethanol can be used. Illustratively, polytetramethylene terephthalate, polyethylene-p-oxybenzoate, poly-1,4-cyclohexanedimethylene terephthalate, or polyethylene-2, 6-naphthalenedicarboxylate can be used.

Of course, these polyesters may be either homopolymer or copolymer. As a component to be copolymerized, a diol component such as diethylene glycol, neopentyl glycol or polyalkylene glycol and a dicarboxylic acid such as adipic acid, sebacic acid, phthalic acid, isophthalic acid or 2,6-naphthalenedicarboxylic acid can be used.

In accordance with an illustrative embodiment, a blend of amorphous poly-1,4-cyclohexanedimethylene terephthalate and crystalline poly ethylene terephthalate is beneficial in providing relatively reduced curl and in providing dimensional stability, as well as water resistance, chemical resistance and processing durability. Moreover, in the example embodiment, the curl performance of the reflector film 200 includes the second layers 202 that surround a first layer 201.

As stated, layer 201 is a voided layer. Layers 201 and 202 may be integrally formed using a co-extrusion or extrusion coating process. The polyester of the first layer 201 can be any of the crystalline polyesters described previously for the second layer 202. Suitably, the polyester is polyethylene (terephthalate). The voids of the first layer 201 are formed by finely dispersing a polymer incompatible with the matrix polyester material and stretching the film uniaxially or biaxially. When the layer 201 is stretched, a void is formed around each particle of the incompatible polymer. Since the formed fine voids operate to diffuse a light, the film is whitened and a higher reflectance can be obtained. The incompatible polymer is a polymer that does not dissolve into the polyester. Examples of such an incompatible polymer include, but are not limited to, poly-3-methylbutene-1, poly-4-methylpentene-1, polypropylene, polyvinyl-t-butane, 1,4-transpoly-2,3-dimethylbutadiene, polyvinylcyclohexane, polystyrene, polyfluorostyrene, cellulose acetate, cellulose propionate and polychlorotrifluoroethylene. Among these polymers, polyolefins such as polypropylene are suitable.

The content of the incompatible polymer in the first layer 201 is desirably in the range of approximately 5 wt % to approximately 30 wt %. If the content is lower than the above range, the desired reflectance is difficult to obtain. If the content is higher than the above range, the strength of the film becomes too low for processing.

In an embodiment, the reflector layer 200 is heat set immediately after stretching the layer 200 in the machine and cross machine directions. The blends of amorphous and crystalline polyester provide the layer 200 with the ability to be heat set without substantial loss of reflectance as well as improving the curl and lay-flat properties of the film. The amorphous nature of this polymer results in a less brittle pre-stretched cast sheet allowing for the high levels of barium sulfate concentration without cracks forming prior to stretching. Various kinds of known additives may be introduced to the polyester; for example, an oxidation inhibitor, or an antistatic agent may be added by a volume which does not destroy the characteristic or the benefits of the reflector layer 200 of the example embodiments. It is noted that the additives would likely be introduced into layer 201.

A process for producing a reflective layer with a first layer 201 and a second layer 202 disposed thereover is described presently in conjunction with an illustrative embodiment. The fabrication sequences of the example embodiments may include extrusion, stretching and heat setting of the materials as described. It is emphasized that the fabrication sequence of the example embodiment is merely illustrative, and as such, other fabrication techniques may be used to effect the reflective films will be readily apparent to one of ordinary skill in the art, having had the benefit of the present disclosure. Finally, it is noted that additional sequence is described to provide a second layer 202 over each side of the first layer 201 is also described.

In the fabrication of the second layer 202, barium sulfate is mixed into poly (ethylene 1,4-cyclohexane dimethylene) and poly (ethylene terephthalate) in a twin screw extruder at a temperature of approximately 260° C. to approximately 280° C. This mixture is extruded through a strand die, cooled in a water bath, and pelletized. The pellets are then-dried at 65° C. and fed into an extruder “A.”

In the fabrication of the first layer 201, polypropylene is blended as an incompatible polymer with polyethylene terephthalate. After sufficient blending and drying at 120° C., the mixture is supplied to an extruder “B” heated at a temperature of 270-290° C.

The two kinds of polymers are co-extruded in a multi-manifold die or feed block in conjunction with a single manifold die to form a laminated structure of A/B or A/B/A; to wit, a structure comprised of the second layer 202 over the first layer 201, or a structure comprised of the second layer 202, the first layer 201 and the second layer 202, respectively.

The molten sheet delivered from the die is cooled and solidified on a drum having a temperature of approximately 50° C. to approximately 70° C. while applying either an electrostatic charge or a vacuum. The sheet is stretched in the longitudinal direction at a draw ratio of approximately 2 times to approximately 5 times during passage through a heating chamber, and thereafter, the film is introduced into a tenter while the edges of the film are clamped by clips. This stretching provides voids in both the first and second layers, to degrees that depend on the concentration of the void-inducing agent (e.g., barium sulfate).

In a tenter, the film is stretched in the transverse direction in a heated atmosphere having a temperature of 90-140° C. This subjecting of the film to heat results in some crystallizing of the polymers of the layers 201 and 202. Although both the draw ratios in the longitudinal and transverse directions are in the range of 2 to 5 times, the area ratio between the non-stretched sheet comprised of the first layer 201 and the second layer 202 is increased significantly. To this end, both layers (201 and 202) are stretched together and the resultant area of the layer 200 is increased by the product of the longitudinal and transvers stretch ratios. Beneficially, the biaxially stretched layer 200 is increased by approximately 8 to 12 times of its original area. If the area ratio is less than approximately 8 times, reflectance of the stretched film is insufficient. If the area ratio is greater than approximately 12 times, a deleterious breakage of the stretched film may occur.

Next, the layer 200 is heat set at a temperature of approximately 177° C. for a time between 1 and 5 seconds. This heat setting provides additional crystallization of the first and second layers, with polyethylene terephthalate (PET) present each acting as a seed for the crystallization. Ultimately, the crystallization of portions of the second layer 202 fosters acceptable shrinkage, curl and reflectance after the duration testing. To this end, the amorphous material in layer 202 will tend to shrink and curl during the duration testing. This is disadvantageous for two reasons. First, the shrinkage and curl can be too great for practical manufacturing. Second, as the amorphous material shrinks, so do the voids, and the reflectance, which is due to the voids, also decreases. However, these disadvantages are substantially avoided in the example embodiments.

The reflector layer 200 thus obtained has a high reflectance of not less than 94% in the range of wavelength of a light of approximately 400 nm to approximately 700 nm. When the reflector 200 is used as a substrate for a reflector of a surface light source having a side light system, a high light efficiency can be obtained. To this end, the level of reflectance provided by the reflector layer 200 increases the overall efficiency by a value greater than its increase in reflectance over a known reflector. Further, since the layer 200 according to an example embodiment has an excellent mean reflectance in the range of wavelength from approximately 400 nm to approximately 700 nm, the film can be utilized for various uses other than a reflector of a surface light source.

### EXAMPLES

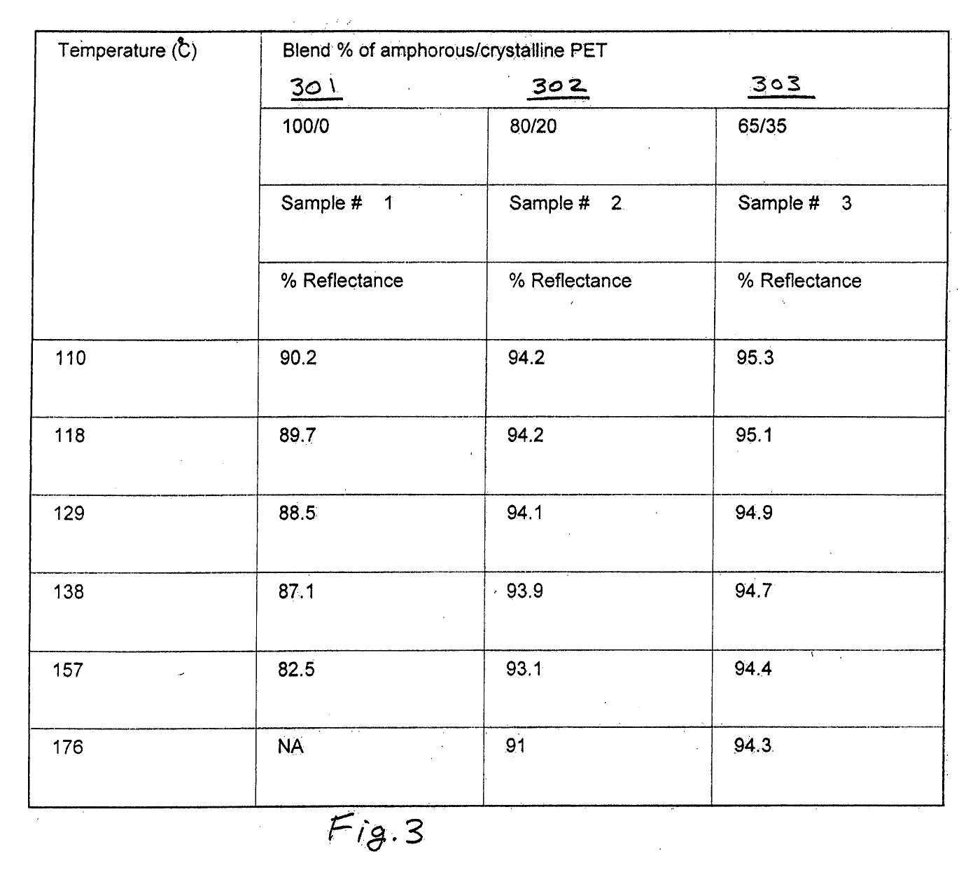

Examples of reflector films of the example embodiments are given to further describe the example embodiments. These examples are merely illustrative and in no way limit the scope of the embodiments. These data are shown in FIG. 3.

### Example 1

### Control

A three-layer film (with designated layers 1, 2 and 3, which are illustratively second layer 202, first layer 201 and second layer 202) comprising voided polyester matrix layers was prepared in the following manner. Materials used in the preparation of layers 1 and 3 of the film were formulated by first compound blending 60% by weight of barium sulfate (BaSO₄) particles approximately 0.7 μm to approximately 2.0 μm in diameter (Blanc Fixe XR-HN available from Sachtleben Corp.) and 40% by weight PETG 6763 resin (IV=0.73 dl/g) (an amorphous polyester resin available from Eastman Chemical Company). The BaSO₄ inorganic particles were compounded with the PETG polyester by mixing in a counter-rotating twin-screw extruder attached to a strand die. Strands of extrudate were transported through a water bath, solidified, and fed through a pelletizer, thereby forming pellets of the resin mixture. A titanium dioxide in polyester concentrate (9663E0002 from Eastman Chemical, a 50/50 concentrate of titanium dioxide and polyester) was then added to the compounded pellets at a 4% by weight. This resulted in a 2% titanium dioxide concentration in the blend. The blended pellets were then dried in a desiccant dryer at 65° C. for 12 hours.

As the material for layer 2, poly(ethylene terephthalate) (#7352 from Eastman Chemicals Company) was dry blended with polypropylene (“PP”, Huntsman P4G2Z-073AX) at 20% weight and dried in a desiccant dryer at 65° C. for 12 hours.

Cast sheets of the noted materials were co-extruded to produce a combined support having the following layer arrangement: layer 1/layer 2/layer 3, using a 2.5 inch (6.35 cm) extruder to extrude layer 2, and a 1 inch (2.54 cm) extruder to extrude layers 1 and 3. The 275° C. melt streams were fed into a 7 inch (17.8 cm) multi-manifold die also heated at 275° C. As the extruded sheet emerged from the die, it was cast onto a quenching roll set at 55° C. The PP in layer 2 dispersed into globules between 10 and 30 μm in size during extrusion. The final dimensions of the continuous cast multilayer sheet were 18 cm wide and 448 μm thick. Layers 1 and 3 were each 140 μm thick while layer 2 was 168 μm thick. The cast multilayer sheet was then stretched at 110° C. first 3.0 times in the X-direction and then 3.4 times in the Y-direction. The stretched sheet was then heat set at various levels from approximately 110° C. to approximately 157° C. and its final thickness is on the order of approximately 75 μm.

### Example 2

### 75 Microns Thick Film

A 3-layer film (with designated layers 1, 2 and 3) comprising voided polyester matrix layers was prepared in the following manner. Materials used in the preparation of layers 1 and 3 of the film were formulated by first compound blending approximately 60% by weight of barium sulfate (BaSO₄) particles approximately 0.7 μm to approximately 2.0 μm in diameter (Blanc Fixe XR-HN available from Sachtleben Corp.) and approximately 40% by weight of a blend consisting of approximately 80% by weight PETG 6763 resin (IV=0.73 dl/g) (an amorphous polyester resin available from Eastman Chemical Company) and approximately 20% (PET), poly(ethylene terephthalate) (#7352 from Eastman Chemicals Company.

The BaSO₄ inorganic particles were compounded with the polyesters by mixing in a counter-rotating twin-screw extruder attached to a strand die. Strands of extrudate were transported through a water bath, solidified, and fed through a pelletizer, thereby forming pellets of the resin mixture.

A titanium dioxide in polyester concentrate (9663E0002 from Eastman Chemical, a 50/50 concentrate of titanium dioxide and polyester) was then added to the compounded pellets at approximately 4% by weight. This resulted in an approximately a 2% titanium dioxide concentration in the blend. The blend was then dried in a desiccant dryer at 65° C. for 12 hours.

As the material for layer 2, poly(ethylene terephthalate) (#7352 from Eastman Chemicals Company) was dry blended with polypropylene(“PP”, Huntsman P4G2Z-073AX) at approximately 20% weight and dried in a desiccant dryer at 65° C. for 12 hours.

Cast sheets of the noted materials were co-extruded to produce a combined support having the following layer arrangement: layer 1/layer 2/layer 3, using a 2.5 inch (6.35 cm) extruder to extrude layer 2, and a 1 inch (2.54 cm) extruder to extrude layers 1 and 3. The 275° C. melt streams were fed into a 7 inch (17.8 cm) multi-manifold die also heated at 275° C. As the extruded sheet emerged from the die, it was cast onto a quenching roll set at 55° C. The PP in layer 2 dispersed into globules between approximately 10 μm and approximately 30 μm in size during extrusion. The final dimensions of the continuous cast multilayer sheet were 18 cm wide and 448 μm thick. Layers 1 and 3 were each 140 μm thick while layer 2 was 168 μm thick. The cast multilayer sheet was then stretched at approximately 110° C. first 3.0 times in the X-direction and then 3.4 times in the Y-direction. The stretched sheet was then heat set at various levels from approximately 110° C. to approximately 177° C. and its final thickness was approximately 75 μm.

### Example 3

### 75 Microns Thick Film

A 3-layer film (with designated layers 1, 2 and 3) comprising voided polyester matrix layers was prepared in the following manner. Materials used in the preparation of layers 1 and 3 of the film were formulated by first compound blending approximately 60% by weight of barium sulfate (BaSO₄) particles approximately 0.7 μm to 2.0 μm in diameter (Blanc Fixe XR-HN available from Sachtleben Corp.) and 40% of a dry blend consisting of approximately 65% by weight PETG 6763 resin (IV=0.73 dl/g) (an amorphous polyester resin available from Eastman Chemical Company) and approximately 35% (PET), poly(ethylene terephthalate) (#7352 from Eastman Chemicals Company.

The BaSO₄ inorganic particles were compounded with the polyesters by mixing in a counter-rotating twin-screw extruder attached to a strand die. Strands of extrudate were transported through a water bath, solidified, and fed through a pelletizer, thereby forming pellets of the resin mixture.

A titanium dioxide in polyester concentrate (9663E0002 from Eastman Chemical, a 50/50 concentrate of titanium dioxide and polyester) was then added to the compounded pellets at a 4% by weight. This resulted in an approximately 2% titanium dioxide concentration in the blend. The blend was then dried in a desiccant dryer at 65° C. for 12 hours.

As the material for layer 2, poly(ethylene terephthalate) (#7352 from Eastman Chemicals Company) was dry blended with polypropylene(“PP”, Huntsman P4G2Z-073AX) at approximately 20% weight and dried in a desiccant dryer at approximately 65° C. for 12 hours.

Cast sheets of the noted materials were co-extruded to produce a combined support having the following layer arrangement: layer 1/layer 2/layer 3, using a 2.5 inch (6.35 cm) extruder to extrude layer 2, and a 1 inch (2.54 cm) extruder to extrude layers 1 and 3. The 275° C. melt streams were fed into a 7 inch (17.8 cm) multi-manifold die also heated at 275° C. As the extruded sheet emerged from the die, it was cast onto a quenching roll set at 55° C. The PP in layer 2 dispersed into globules between approximately 10 μm and 30 μm in size during extrusion The final dimensions of the continuous cast multilayer sheet were 18 cm wide and 448 μm thick. Layers 1 and 3 were each 140 μm thick while layer 2 was 168 μm thick. The cast multilayer sheet was then stretched at 110° C. first 3.0 times in the X-direction and then 3.4 times in the Y-direction. The stretched sheet was then heat set at various temperatures from approximately 110° C. to approximately 177° C. and its final thickness was approximately 75 μm.

FIG. 3 is a tabular representation of the reflectance for various levels of PET and heat-set temperatures. The reflectance is determined as follows. A 60 mm integrating sphere is attached to a spectrophotometer (Perkin Elmer Lambda 800). A reflectance is determined in the ranges of wavelengths from 200 to 700 nm. The reflectance of Spectralon is defined as 100% and the measured reflectances are based on a comparison to the Spectralon. A value is obtained at an interval of 1 nm, and the average value over any defined wave length range is defined as the mean reflectance. The reflectance at wavelengths from 200 to 400 nm is considered here as UV light reflectance. The mean reflectance at wavelengths from approximately 400 nm to approximately 700 nm is considered visible light reflectance.

The first sample 301 is amorphous polyester, the second sample 302 is 80 wt % amorphous and 20 wt % PET and the third sample is 65 wt % amorphous and 35 wt % PET. The total thickness of the films in each case is 75 μm.

As can be readily appreciated from FIG. 3, the third sample 303 provided a reflectance over temperature between 95.3% and 94.3%.

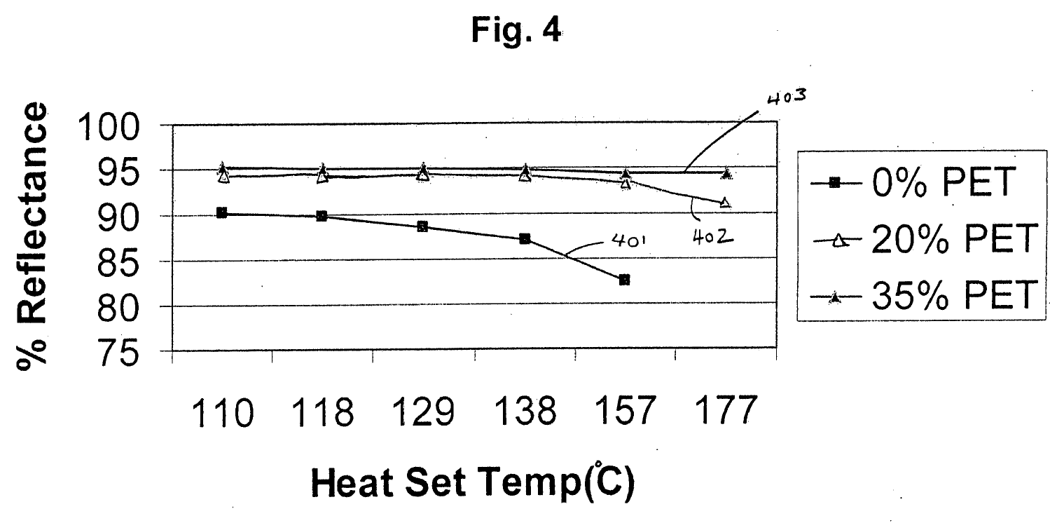

FIG. 4 is a graphical representation showing the impact of heat set temperature as a function of amorphous polyester versus crystalline PET and its impact on dimensional stability and reflectance. Curve 401 shows the reflectance of the film of example 1 with substantially no PET. Thus, this layer is an amorphous and voided layer. As can be appreciated, during the heat-set sequence, the reflectance decreases as the voids are decreased with increased heat-set temperature.

Curve 402 shows a significant increase in the reflectance versus temperature with approximately 20 wt % crystalline PET added to the otherwise amorphous polyester layer of example 2. During the heat-set sequence, the PET present in the layer act as seeds for further crystallization, which together with the PET provides structure to the layer. This reduces the shrinking of voids and the layer in general.

Finally, curve 403 a substantially constant reflectance across the heat-set temperature range. This is provided by inclusion of approximately 35% PET to the otherwise amorphous polyester layer of example 3. It is noted that adding PET maintains reflectance with higher heat setting and also increases the starting reflectance. However, if more than approximately 35% PET is added, brittleness of the cast sheet occurs and thus manufacturability is liable to deteriorate.

The shrinkage in percent (%) versus the percentage of PET provided in layer 202 over a durability test (e.g., 80° C. dry ambient for 120 hrs.) shows benefits compared to known fabrication methods and products. Thermal shrinkage measurements were performed using samples with dimensions of approximately 35 mm wide by minimum of approximately 12 inches long. Each strip is placed in a punch to obtain a preset 10-inch gauge length. The actual gauge length is measured using a device calibrated with a 10-inch invar bar preset to measure 10-inch samples. This length is recorded to 0.0001 inches using a digital micrometer. Once the initial length is determined, samples are placed in an oven at the prescribed temperature for the necessary time interval. Samples are then removed from the oven and allowed to cool for a minimum of approximately 2 hours but generally approximately 12 hours. The final sample length is re-measured using the same setup used to determine the initial length. The shrinkage is reported in percent using the following equation:
final value−initial value)×100

It is noted that the negative (−) sign associated with the shrinkage denotes direction of the change.

In an example embodiment, the total film thickness of the examples is 75 μm. Using standard heat shrinkage methods reveals an unacceptable 12.17% shrinkage for a sample with no PET in layer 202, versus a shrinkage of approximately 2% for a layer of an example embodiment having approximately 35% PET in layer 202. In this embodiment, the heat Settemperature was on the order of 121° C. At a heat set temperature of 177° C., the heat shrinkage of the example embodiment having 35% PET was only approximately 0.83%. Similarly, the curl was unacceptable in known structures with no PET in layer 202, whereas it was acceptable in the example embodiment with approximately 35% PET in layer 202.

From the above, it is clear that the inclusion of PET in layer 202, among other factors of the example embodiments, provides significant improvement to the example embodiments compared to the known materials.

In accordance with illustrative embodiments, diffuse reflectors used in the backlight assembly of a typical liquid crystal display, provide an improved optical efficiency (illuminance) compared to known structures that include specular reflectors over certain surfaces of the light guide. Further, the various methods, materials, components and parameters are included by way of example only and not in any limiting sense. Therefore, the embodiments described are illustrative and are useful in providing beneficial backlight assemblies. In view of this disclosure, those skilled in the art can implement the various example devices and methods to effect improved backlight efficiency, while remaining within the scope of the appended claims.

1. A reflective layer, comprising:
a first layer comprised at least partially of a crystalline material; and
a second layer, which comprises polyester and which is voided sufficiently to provide a reflectivity of at least 94%, wherein the first layer and the second layer have a combined thickness of at most 150 μm.

2. A reflective layer as recited in claim 1, wherein the first layer includes a plurality of voids.

3. A reflective layer as recited in claim 1, wherein the second layer is comprised partially of a crystalline material.

4. A reflective layer as recited in claim 3, further comprising at least a third layer, which is comprised at least partially of a crystalline material and which is disposed beneath the first layer.

5. A reflective layer as recited in claim 4, wherein the second layer is disposed over the first layer.

6. A reflective layer as recited in claim 1, wherein the first layer comprises a polyester material.

7. A reflective layer as recited in claim 2, wherein the second layer includes approximately 5 wt % to approximately 45 wt % of a crystallizable polyester.

8. A reflective layer as recited in claim 2, wherein the second layer includes approximately 20 wt % to approximately 40 wt % of a crystallizable polyester.

9. A reflective layer as recited in claim 2, wherein the second layer includes at most approximately 35 wt % of a crystallizable polyester.

10. A reflective layer as recited in claim 1, wherein the first layer comprises approximately 50% to approximately 70% of the thickness of the reflective layer.

11. A reflective layer as recited in claim 1, wherein the reflective layer has a thickness of less than approximately 75 μm and a reflectance of approximately 94%.

12. A reflective layer as recited in claim 1, further comprising an antistatic material.

13. A reflective layer as recited in claim 11, wherein the shrinkage after duration testing is less than approximately 2.4%.

14. A reflective layer as recited in claim 6, wherein the polyester is a polymer obtained by the condensation polymerization, at least in part, of a diol and a dicarboxylic acid.

15. A reflective layer as recited in claim 1, wherein the polyester is a polymer obtained by the condensation polymerization, at least in part, of a diol and a dicarboxylic acid.

16. A reflective layer as recited in claim 1, wherein the second layer includes barium sulfate.

17. A reflective layer as recited in claim 16, wherein the barium sulfate comprises particles having a diameter of approximately 0.5 μm to approximately 2.0 μm.

18. A reflective layer as recited in claim 7, wherein the crystalline polyester is PET.

19. A reflective layer as recited in claim 8, wherein the crystalline polyester is PET.

20. A reflective layer as recited in claim 7, wherein after a heat shrinking process, the reflective layer shrinks less than approximately 2.0%.

21. A method of fabricating a reflecting layer, the method comprising:
forming a first layer, which is at least partially crystalline;
forming a second layer, which is at least partially amorphous; and
crystallizing a portion of the second layer, wherein the reflective layer has a reflectivity of at least 94%, and the first layer and the second layer have a combined thickness of at most 150 μm.

22. A method as recited in claim 21, wherein the method further comprises voiding portions of the second layer.

23. A method as recited in claim 21, wherein the method further comprises, extruding and stretch voiding the first and second layers; and
heat-setting the first and second layers.

24. A method as recited in claim 21, wherein the method further comprises adding crystalline material to the second layer.

25. A method as recited in claim 26, wherein the second layer includes at most approximately 35 wt % of a crystallizable polymer.

26. A method as recited in claim 23, wherein the second layer comprises 5 wt % to approximately 45 wt % of a crystallizable polyester.

27. A method as recited in claim 23, wherein the second layer comprises approximately 20 wt % to approximately 40 wt % of a crystallizable polyester.

28. A method as recited in claim 21, wherein the method further comprises forming the polyester by condensation polymerization, at least in part, of a diol and a dicarboxylic acid.

29. A method as recited in claim 21, wherein the first layer comprises a polyester.

30. A method as recited in claim 29, wherein the method further comprises forming the polyester by condensation polymerization, at least in part, of a diol and a dicarboxylic acid.

31. A method as recited in claim 21, wherein the method further comprises voiding at least a portion of the second layer.

32. A method as recited in claim 21, wherein the first layer comprises approximately 50% to approximately 70% of the thickness of the reflective layer.
